(19) United States
(12) Patent Application Publication
(10) Pub. No.: US 2015/0043871 A1
(43) Pub. Date: Feb. 12, 2015

(54) OPTICAL CONNECTOR

(71) Applicant: SUMITOMO ELECTRIC INDUSTRIES, LTD., Osaka (JP)

(72) Inventor: Yuuichi MITOSE, Yokohama-shi (JP)

(21) Appl. No.: 14/453,817

(22) Filed: Aug. 7, 2014

(30) Foreign Application Priority Data
Aug. 9, 2013 (JP) 2013-166892
Aug. 9, 2013 (JP) 2013-166893

(51) Int. Cl. G02B 6/38

(52) U.S. Cl. CPC G02B 6/38
USPC 385/76

(57) ABSTRACT

An optical connector is an optical connector for converting optical paths of an MCF arranged in a first arrangement into a second arrangement. A plurality of cores are arranged in three stages in the first arrangement and one stage in the second arrangement. The optical connector comprises a first end 10, placed on the MCF side, for arranging respective one ends of optical fibers in the first arrangement. The optical connector also comprises a second end for arranging the respective other ends or middle parts of the plurality of optical fibers in the second arrangement. A plurality of optical fibers arranged at the n-th stage in the first end do not intersect each other in a space as seen in a second direction.

### FIELD OF THE INVENTION

The present invention relates to an optical connector for converting a plurality of optical paths arranged within the same cladding in a multicore fiber.

### BACKGROUND OF THE INVENTION

Recently, it has been desired for optical transmissions to increase their capacities, and it has been proposed to transmit light between a transmission device and various terminals through a multicore fiber having a plurality of optical paths within the same cladding. On the other hand, optical devices on the terminal side have been presupposed to be connected through a single-core fiber having one optical path within the same cladding. Therefore, when a multicore fiber is used, it is necessary for the respective optical paths of the multicore fiber to be connected to the respective optical paths of single-core fibers. International Publication No. 2012/172906 proposes an optical connection member which converts an arrangement of optical paths in a multicore fiber so as to connect them to single-core fibers and the like. Further, Japanese Patent Application Laid-Open No. 2010-286661, International Publication No. 2012/121318, International Publication No. 2013/051656, and Japanese Patent Application Laid-Open No. 2007-279194 also disclose techniques in such a field.

### SUMMARY OF THE INVENTION

The optical connection member disclosed in International Publication No. 2012/172906 converts an arrangement of optical paths in a multicore fiber. However, this may twist optical fibers incorporated in the optical connection member. Hence, there has been a demand for a technique which, in a simple structure, can ameliorate characteristics of light transmitted.

One aspect of the present invention is an optical connector for converting an arrangement of a plurality of optical paths provided in a cladding of a multicore fiber from a first arrangement to a second arrangement, the optical connector comprising a plurality of optical fibers for providing optical paths optically connectable to the respective optical paths of the multicore fiber; a first end for placing one end of a plurality of the optical fibers in the first arrangement; a second end for arranging the other end of a plurality of the optical fibers or a middle part thereof in the second arrangement; and a space located between the first end and the second end such that a plurality of the optical fibers extend therethrough from the first end to the second end; the first arrangement includes, one or a plurality of the optical paths arranged in a first direction, and a plurality of the optical paths arranged in N stages in a second direction intersecting the first direction; the second arrangement includes, one or a plurality of the optical paths arranged in the first direction, and a plurality of the optical paths arranged in M stages in the second direction, where N and M are natural numbers, and N>M; and a plurality of the optical fibers arranged at the n-th stage in the first end, where N≧n≧1, being kept from intersecting each other in the space as seen in the second direction.

### BRIEF DESCRIPTION OF THE DRAWINGS

FIG. 1 is a perspective view illustrating the structure of an optical connector in accordance with a first embodiment of the present invention;

FIG. 2 is a transverse sectional view of the optical connector illustrated in FIG. 1;

FIG. 3 is a perspective view of the optical connector illustrated in FIG. 1 without a part thereof;

FIG. 4 illustrates an end face on the multicore fiber side of the optical connector depicted in FIG. 1;

FIG. 5 illustrates an end face on the single-core fiber side of the optical connector depicted in FIG. 1;

FIG. 6A is an arrangement of optical fibers in a first end, while FIG. 6B illustrates how it corresponds to an arrangement of optical fibers in a second end;

FIG. 7A is an arrangement of optical fibers in the first end in accordance with a second embodiment of the present invention, while FIG. 7B illustrates how it corresponds to an arrangement of optical fibers in the second end;

FIG. 8A is an arrangement of optical fibers in the first end in accordance with Modified Example 1 of the present invention, while FIG. 8B illustrates how it corresponds to an arrangement of optical fibers in the second end;

FIG. 9A is an arrangement of optical fibers in the first end in accordance with Modified Example 2 of the present invention, while FIG. 9B illustrates how it corresponds to an arrangement of optical fibers in the second end;

FIG. 10A is an arrangement of optical fibers in the first end in accordance with Modified Example 3 of the present invention, while FIG. 10B illustrates how it corresponds to an arrangement of optical fibers in the second end;

FIG. 11A is an arrangement of optical fibers in the first end in accordance with Modified Example 4 of the present invention, while FIG. 11B illustrates how it corresponds to an arrangement of optical fibers in the second end;

FIG. 12A is an arrangement of optical fibers in the first end in accordance with Modified Example 5 of the present invention, while FIG. 12B illustrates how it corresponds to an arrangement of optical fibers in the second end;

FIG. 13A is an arrangement of optical fibers in the first end in accordance with Modified Example 6 of the present invention, while FIG. 13B illustrates how it corresponds to an arrangement of optical fibers in the second end;

FIG. 14 is a sectional view enlarging a part of FIG. 2;

FIG. 15 illustrates an end face on one end side of an alignment sleeve; and

FIG. 16 illustrates an end face on the other end side of the alignment sleeve.

### DETAILED DESCRIPTION OF THE INVENTION

### DESCRIPTION OF EMBODIMENTS OF INVENTION

First, details of embodiments of the present invention will be listed and explained.

One aspect of the present invention is an optical connector for converting an arrangement of a plurality of optical paths provided in a cladding of a multicore fiber from a first arrangement to a second arrangement, the optical connector comprising a plurality of optical fibers for providing optical paths optically connectable to the respective optical paths of the multicore fiber; a first end for placing one end of a plurality of the optical fibers in the first arrangement; a second end for arranging the other end of a plurality of the optical fibers or a middle part thereof in the second arrangement; and a space located between the first end and the second end such that a plurality of the optical fibers extend therethrough from the first end to the second end; the first arrangement includes one or a plurality of the optical paths arranged in a first direction, and a plurality of the optical paths arranged in N stages in a second direction intersecting the first direction; the second arrangement includes one or a plurality of the optical paths arranged in the first direction, and a plurality of the optical paths arranged in M stages in the second direction, where N and M are natural numbers, and N>M; and a plurality of the optical fibers arranged at the n-th stage in the first end, where N≧n≧1, being kept from intersecting each other in the space as seen in the second direction. This prevents the optical fibers from coming into contact and thereby worsening optical characteristics. Therefore, this optical connector can favorably keep optical characteristics when converting the arrangement of respective optical paths of the multicore fiber into another arrangement.

The optical connector may be configured such that a plurality of the optical fibers arranged in the second end include an optical fiber set constituted by the optical fibers having the one end placed at the n-th stage in the first end, the optical fiber set includes a first optical fiber arranged at an end of the fiber set in the second end, and the one end of the first optical fiber is arranged at an end of the optical fiber placed at the n-th stage in the first end. This configuration reduces the deviation along the first direction between respective positions where both ends of the optical fiber are arranged. As a consequence, bends occurring in the optical fibers become smaller. Hence, stresses acting on the optical fibers can be mitigated.

The optical connector may be configured such that the fiber set further comprises a second optical fiber arranged adjacent to the first optical fiber in the second end, the second optical fiber being arranged adjacent to the first optical fiber in the first end. In this case, optical fibers adjacent to each other in the first end and the second end can be integrated into a ribbon, for example, so as to be arranged in the first end. Hence, the optical connector can be manufactured easily.

The optical connector may be configured such that the first optical fiber and the second optical fiber are integrated into a ribbon in the space. This configuration makes it easy to manufacture the optical connector.

The optical connector may be configured such that N=3 in the first arrangement, M=1 in the second arrangement, the optical fiber set at the first stage (n=1) in the first arrangement includes two of the optical fibers, the optical fiber set at the second stage (n=2) in the first arrangement includes three of the optical fibers, the optical fiber set at the third stage (n=3) in the first arrangement includes two of the optical fibers, the optical fiber set at the second stage of the first arrangement includes the optical fiber arranged at a center in the second end and at a center of the second stage in the first end, the optical fiber arranged offset in the first direction from the optical fiber arranged at the center of the second stage in the second end is arranged at an end in the first direction of a plurality of the optical fibers at the second stage in the first end. This configuration reduces the deviation along the first direction between respective positions where both ends of the optical fiber are placed. As a consequence, bends added to the optical fibers become smaller. Hence, stresses acting on the optical fibers can be mitigated. Further, this configuration can also prevent optical characteristics from deteriorating when converting the arrangement of optical paths of the multicore fiber from three stages to one stage.

The optical connector may be configured such that N=2 in the first arrangement, M=1 in the second arrangement, the optical fiber set at the first stage (n=1) in the first arrangement includes k of the optical fibers, the optical fiber set at the second stage (n=2) in the first arrangement includes k of the optical fibers, the optical fiber arranged at the r-th position, where r is a natural number satisfying k≧r≧1, in the first direction of the first stage in the first end is arranged at the (2×r−1)-th position in the first direction in the second end, and the optical fiber arranged at the r-th position in the first direction at the second stage in the first end is arranged at the (2×r)-th position in the first direction in the second end. This configuration reduces the deviation along the first direction between respective positions where both ends of the optical fiber are placed. As a consequence, bends added to the optical fibers become smaller. Hence, stresses acting on the optical fibers can be mitigated. Further, this configuration can prevent optical characteristics from deteriorating when converting the arrangement of optical paths of the multicore fiber from two stages to one stage.

The optical connector may be configured such that N=3 in the first arrangement, M=1 in the second arrangement, a first fiber set corresponding to the first stage (n=1) in the first arrangement, a second fiber set corresponding to the second stage (n=2) in the first arrangement, and a third fiber set corresponding to the third stage (n=3) in the first arrangement are formed in the second end, the optical fibers included in each of the first, second, and third fiber sets are adjacent to each other in the second end, and the second fiber set is held between the first fiber set and the third fiber set. This configuration can prevent optical characteristics from deteriorating when converting the arrangement of optical paths of the multicore fiber from three stages to one stage. A plurality of optical fibers adjacent to each other can also be arranged collectively in the first end. Therefore, the optical connector can be manufactured easily.

The optical connector may further comprise a ferrule, the ferrule being arranged in the space, secured to the first end, and the optical fiber is inserted therethrough, the a length of the ferrule is longer than that of the optical fiber from the ferrule to the second end. This configuration makes the optical fiber shorter in the space. Hence, this can prevent the fibers from coming into contact in the space.

The optical connector may further comprise a ferrule, the ferrule being arranged in the space, secured to the first end, and the optical fiber is inserted therethrough, a length of the ferrule is shorter than that of the optical fiber from the ferrule to the second end. This configuration makes the optical fiber longer in the space. As a consequence, bends added to the optical fibers become smaller. Hence, stresses acting on the optical fibers can be mitigated.

The optical connector may further comprise an alignment part, placed in the space, for aligning a plurality of the optical fibers extending from the second end into the N stages. This configuration makes it possible to align the optical fibers beforehand and then guide the optical fibers from the second end to the first end.

The optical connector may be configured such that an interval between a plurality of the optical fibers in the respective stages in the alignment part is greater than that in the first arrangement. This configuration can easily align the optical fibers in the alignment part.

The optical connector may be configured such that the first end has an arrangement region for placing the plurality of optical fibers in the first arrangement, while forming a gap between the arrangement region and a leading end of the alignment part and, in the gap, an interval between a plurality of the optical fibers in the respective stages in the alignment part is converted into an interval between a plurality of the optical fibers in the respective stages in the first arrangement. This configuration makes it easy for the optical fibers extending from the leading end of the alignment part to be introduced into the arrangement region in the first end.

The optical connector may be configured such that the alignment part is secured to the first end, and the first end has a taper in at least a part of a region disposed against the gap. This configuration makes it easy for the optical fibers extending from the leading end of the alignment part to be introduced into the first end having a narrower diameter without changing their arrangement.

The optical connector may be configured such that the alignment part has a plurality of through holes for aligning the optical fibers, a width between the through holes being smaller than an inner diameter of the through hole. This configuration can introduce the optical fibers into the first end without changing the fiber arrangement aligned in the alignment part.

The optical connector may be configured such that the space is greater than the width of the first arrangement and the width of the second arrangement in a direction intersecting the opposing direction of the first end and the second end. This configuration can prevent the optical fibers from twisting.

### DETAILED DESCRIPTION OF EMBODIMENTS OF INVENTION

### First Embodiment

In the following, specific examples of the optical connector in accordance with an embodiment of the present invention will be explained with reference to the drawings. Further, the present invention is not limited to the following examples but intends to be defined by the claims and include all the modifications within the scope equivalent to the claims.

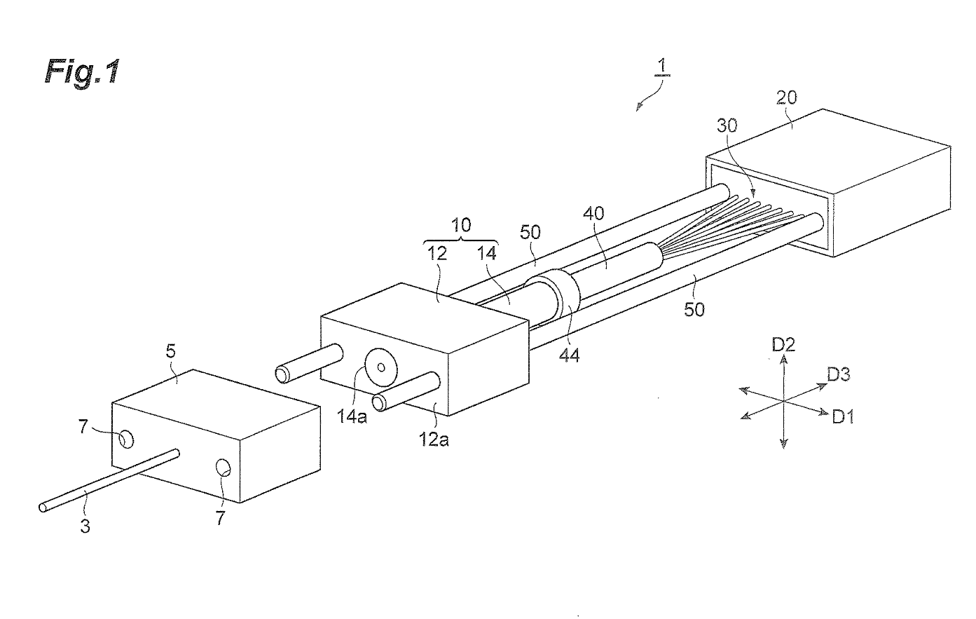

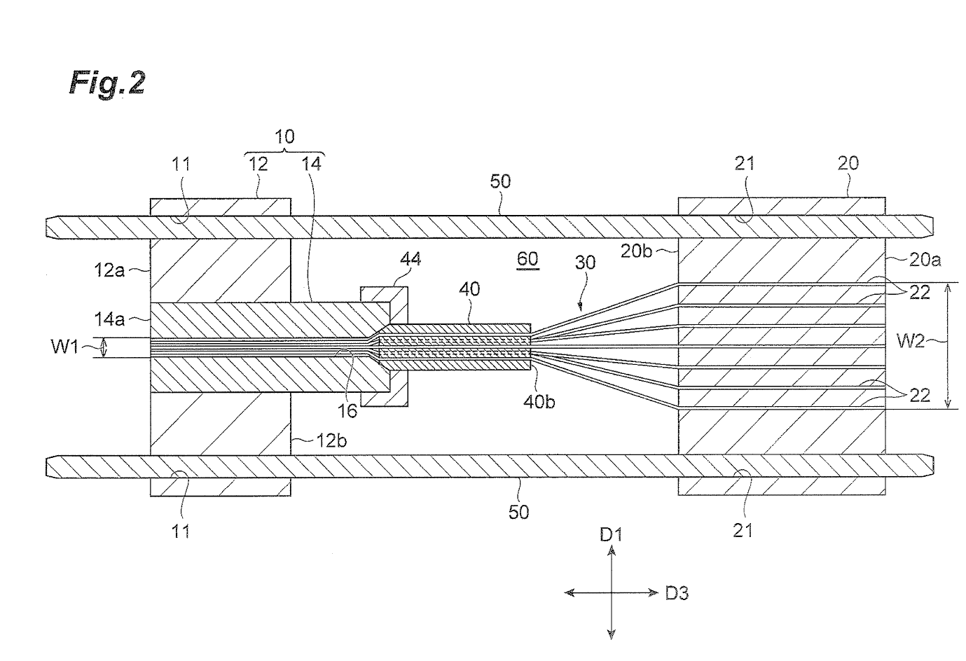

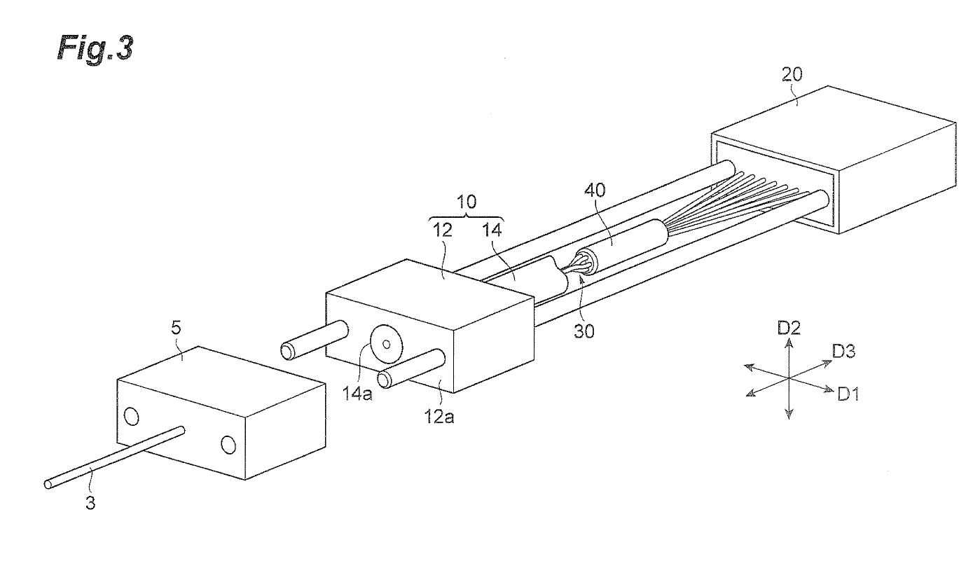

FIG. 1 is a perspective view illustrating the structure of the optical connector in accordance with the first embodiment of the present invention. FIG. 2 is a transverse sectional view of the optical connector illustrated in FIG. 1. FIG. 3 is a perspective view of the optical connector illustrated in FIG. 1 without a part thereof. FIG. 1 illustrates an optical connector 1 and a multicore fiber (hereinafter referred to as “MCF 3”) connected thereto. The MCF 3 is held by a rectangular parallelepiped ferrule 5. The MCF 3 has a leading end exposed to the optical connector 1 side.

The MCF 3 has a plurality of cores (optical paths) arranged in a first arrangement within the same cladding. In the MCF 3, a plurality of cores are arranged in three stages in its vertical direction D2. Two cores are arranged at the first stage, three cores at the second stage, and two cores are arranged at the third stage.

The optical connector 1 converts the arrangement of each optical path of the MCF 3 from the first arrangement to the second arrangement. Specifically, the optical connector 1 converts the arrangement of each optical path in the MCF 3 from the N stages to M stages, where N and M are natural numbers, and N>M.

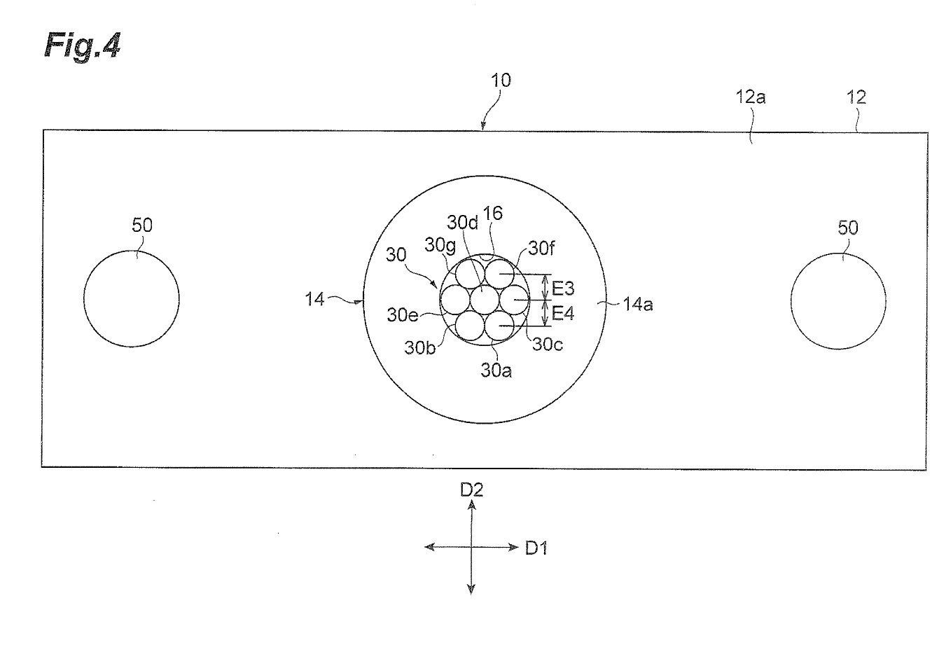

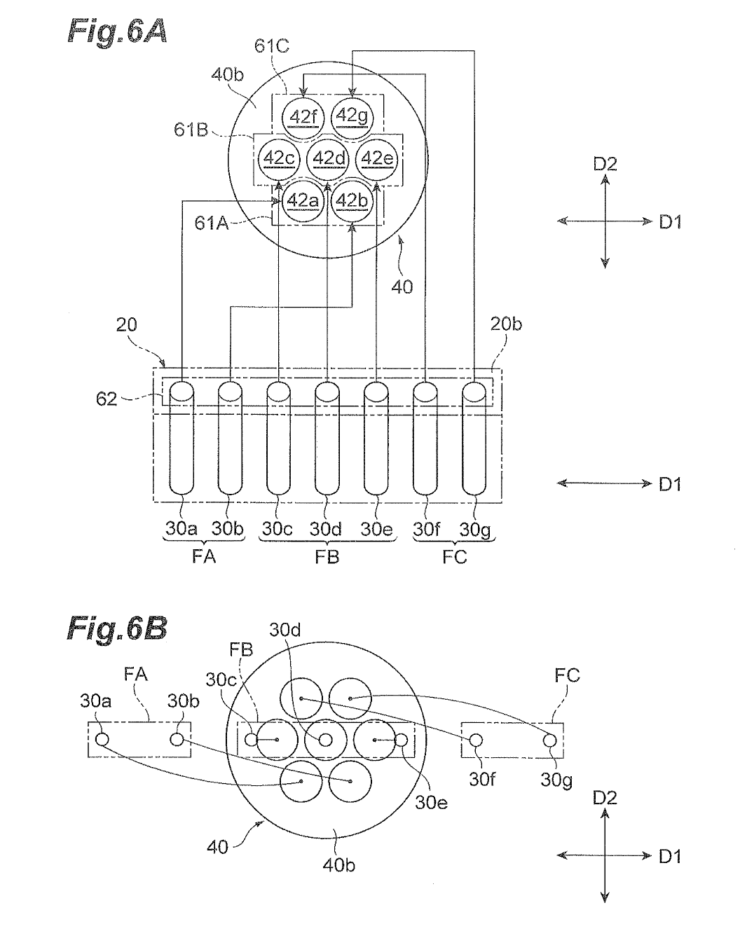

In the first arrangement in this embodiment, a plurality of optical paths are juxtaposed along a first direction (horizontal direction in the following) D1 (see FIG. 6 and the like). The plurality of optical paths are arranged in three stages (N=3) in a second direction (vertical direction in the following) D2 (see FIG. 6 and the like) intersecting the first direction D1. As the first arrangement, FIG. 4 illustrates a three-stage arrangement along the vertical direction D2 (two optical paths at the first stage, three optical paths at the second stage, and two optical paths at the third stage). In this embodiment, the vertical direction D2 is a direction orthogonal to the horizontal direction D1. Further, a third direction D3, which is a direction intersecting the horizontal direction D1 and vertical direction D2, is a direction in which first and second ends 10, 20 oppose (opposing direction D3 in the following).

In the second arrangement in this embodiment, a plurality of optical paths are arranged along the horizontal direction D1. They are arranged in one stage (M=1) in the vertical direction D2.

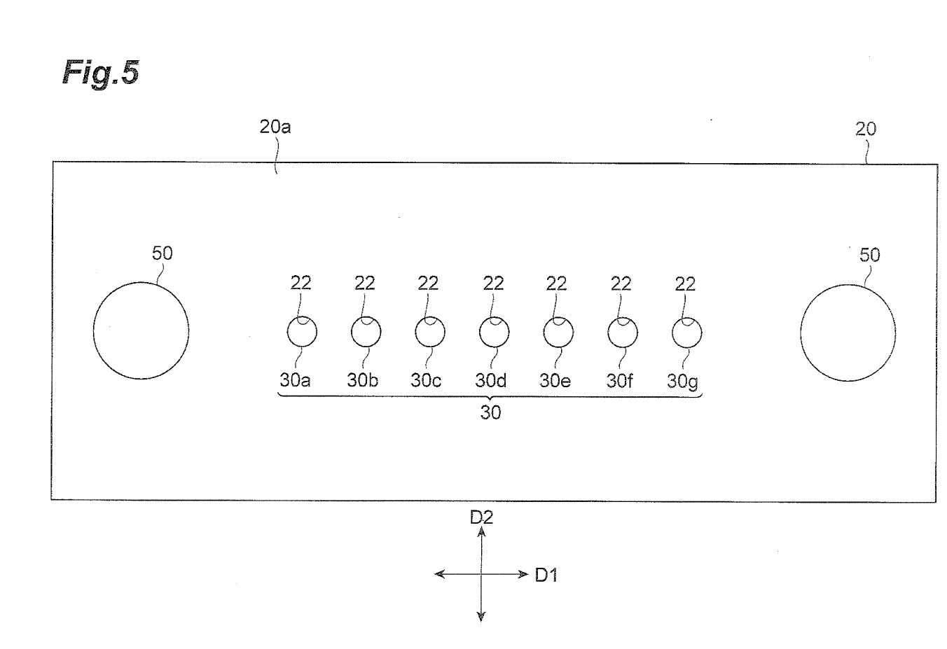

As illustrated in FIGS. 1 and 2, the optical connector 1 comprises the first end 10, the second end 20, an optical fiber group 30, an alignment sleeve 40, and a pair of alignment pins 50. The optical fiber group 30 in this embodiment includes seven optical fibers 30a, 30b, 30c, 30d, 30e, 30f, 30g (see FIG. 5 and the like). As illustrated in FIG. 1, the outer surface 12a of the first end 10 is optically connectable to a ferrule 5. That is, on the outer surface 12a, respective one ends of the optical fibers 30a to 30g are optically connectable to their corresponding cores of the MCF 3. On the outer surface 20a of the second end 20, the respective other ends of the optical fibers 30a to 30g are optically connectable to a plurality of other single-core fibers (not depicted).

As illustrated in FIG. 4, the first end 10 is arranged on the MCF 3 side. The first end 10 arranges respective one ends of the optical fibers 30a to 30g into the same arrangement (first arrangement) as with the core arrangement in the MCF 3. The first end 10 is formed from a resin having a low coefficient of linear expansion. Examples of such a resin include PPS (polyphenylenesulfide) and PEI (polyetherimide).

The first end 10 further comprises a ferrule 14. The ferrule 14 is a cylindrical member formed from zirconia or the like. The outer surface 14a of the ferrule 14 coincides with the outer surface 12a of one end of a main 12. The ferrule 14 is secured to the main 12 such that its inner surface 12b projects toward the second end 20.

The optical fibers 30a to 30g are held in the first arrangement within the ferrule 14. Further, the ferrule 14 has one through hole 16 (arrangement region) for holding the optical fibers 30a to 30g. The one ends of the optical fibers 30a to 30g are held in the first arrangement in the through hole 16 of the ferrule 14. As illustrated in FIG. 4, the optical fibers 30a to 30g are arranged in a triangular lattice in this embodiment. That is, six optical fibers 30a, 30b, 30c, 30e, 30f, 30g are arranged at intervals of 60° around the optical fiber 30d at their center. The optical fibers 30a to 30g arranged within the through hole 16 are held parallel to each other along the opposing direction D3.

The second end 20 is arranged on a side different from the first end 10. Specifically, the second end 20 is arranged on the side opposite from the first end 10. In the second end 20, the respective other ends of the optical fibers 30a to 30g are arranged into the second arrangement. As the second arrangement, FIG. 5 illustrates a one-stage arrangement along the vertical direction D2 (seven optical fibers at the first stage). In the second direction D2, the number of stages in the second arrangement is smaller than that in the first arrangement.

The second end 20 has a rectangular parallelepiped form. Further, the second end 20 is formed from a resin such as PPS or PEI as with the first end 10.

The second end 20 has a plurality of through holes 22. The through holes 22 extend in parallel with each other along the opposing direction D3. Each through hole 22 has an inner diameter substantially the same as the outer diameter of each of the optical fibers 30a to 30g. The respective other ends of the optical fibers 30a to 30g are arranged within the through holes 22 so as to extend to the outer surface 20a at the other end of the second end 20.

As illustrated in FIG. 5, the plurality of through holes 22 are arranged in one row along the horizontal direction D1. The plurality of through holes 22 are arranged in the second arrangement. This arranges the respective other ends of the optical fibers 30a to 30g into the second arrangement.

Further, the optical connector may be of a pigtail type in which the optical fibers 30a to 30g further extend to the outside from the outer surface 20a. In this ease, the second end 20 arranges middle parts of the optical fibers 30a to 30g into the second arrangement.

The first end 10 and the second end 20 are provided with through holes 11, 21. Inserting the alignment pins 50 into the through holes 11, 21 restricts positions of the first end 10 and the second end 20 relative to each other. The alignment pins 50 further extend from the first end 10 to the outside, so as to be inserted into through holes 7 of the ferrule 5. This allows the arrangement pins 50 to restrict the arrangement between the optical connector 1 and the ferrule 5. The first end 10 and the ferrule 5 are secured to each other with a clip and the like.

A space 60 is formed between the first end 10 and the second end 20. The space 60 has a lateral width greater than each of the first arrangement width W1 and the second arrangement width W2 of the optical fibers 30a to 30g in the horizontal direction D1. The space 60 is not filled with a resin and the like and thus can prevent the optical fibers 30a to 30g from being damaged when temperature changes.

Each of the optical fibers 30a to 30g is a single-core optical fiber. The optical fibers 30a to 30g have respective one ends held by the first end 10 and are optically connectable to the respective cores of the MCF 3. Further, the respective other ends of the optical fibers 30a to 30g are held by the second end 20. The number of optical fibers 30a to 30g may be changed as appropriate according to the number of optical paths included in the MCF 3. As illustrated in FIGS. 4 and 5, the optical fibers 30a to 30g are arranged two-dimensionally in the first end 10 and one-dimensionally in the second end 20. In the space 60, the optical fibers 30a to 30g expand from the two-dimensional arrangement to the one-dimensional arrangement from the first end 10 toward the second end 20.

The alignment sleeve 40 is a cylindrical member constituted by a metal such as nickel, for example. The alignment sleeve 40 has a length shorter than the distance from the inner surface 20b of the second end 20 to an end face 40b of the alignment sleeve 40. The alignment sleeve 40 functions as an alignment part for aligning the optical fibers 30a to 30g extending from the second end 20 into N stages. The alignment sleeve 40 introduces the optical fibers 30a to 30g into the through hole 16 of the ferrule 14 without changing the arrangement of optical fibers.

As illustrated in FIG. 6, the alignment sleeve 40 has a plurality of (7 in this embodiment) through holes 42a to 42g therewithin. The through holes 42a to 42g are formed along the opposing direction D3. The optical fibers 30a to 30g are arranged within the through holes 42a to 42g, respectively. The through holes 42a to 42g include two at the first stage, three at the second stage, and two at the third stage. The through holes 42a to 42g are arranged in a triangular lattice in three stages so as to correspond to the first arrangement. That is, six through holes 42a, 42b, 42c, 42e, 42f, 42g are arranged at intervals of 60° about one through hole 42d arranged at the center.

Such a structure enables the optical connector 1 to convert the arrangement of the optical fibers 30a to 30g from the first arrangement to the second arrangement from the first end 10 side to the second end 20 side.

The structure by which the optical fibers 30a to 30g put in the alignment sleeve 40 are introduced into the ferrule 14 without changing their arrangement will now be explained in detail.

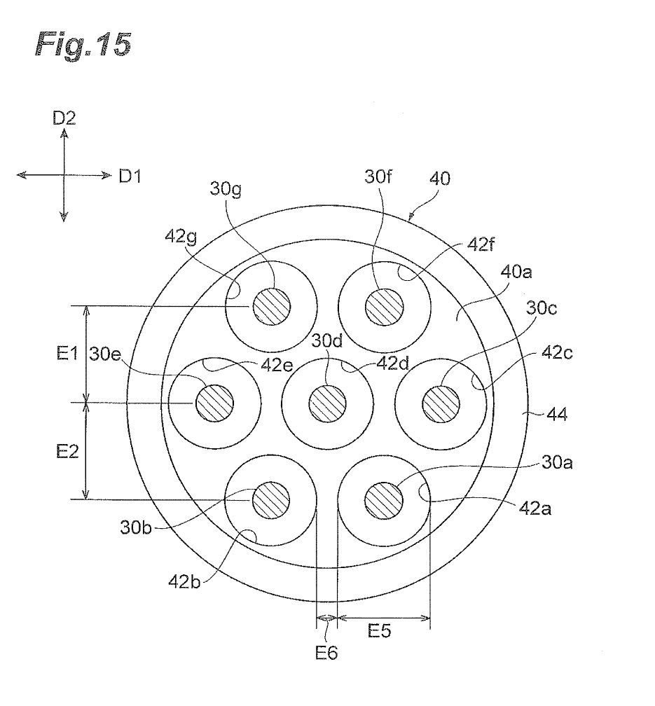

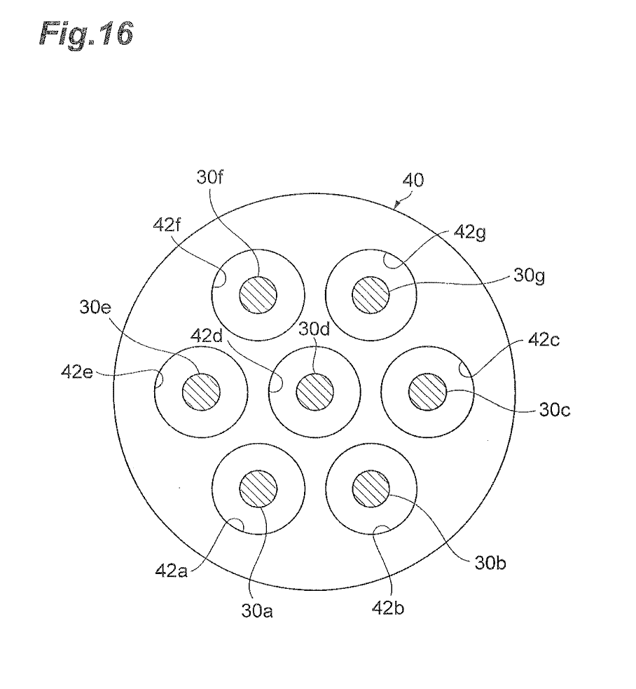

As illustrated in FIGS. 15 and 16, the optical fibers 30a to 30g are arranged in the through holes 42a to 42g, respectively. Each of center distances E1, E2 in the vertical direction D2 between the optical fibers 30a to 30g in the adjacent stages is greater than the center distance in the vertical direction D2 between the cores of the MCF 3. Further, it is also greater than each of center distances E3, E4 in the vertical direction D2 between the optical fibers 30a to 30g in the first end 10 (see FIG. 4).

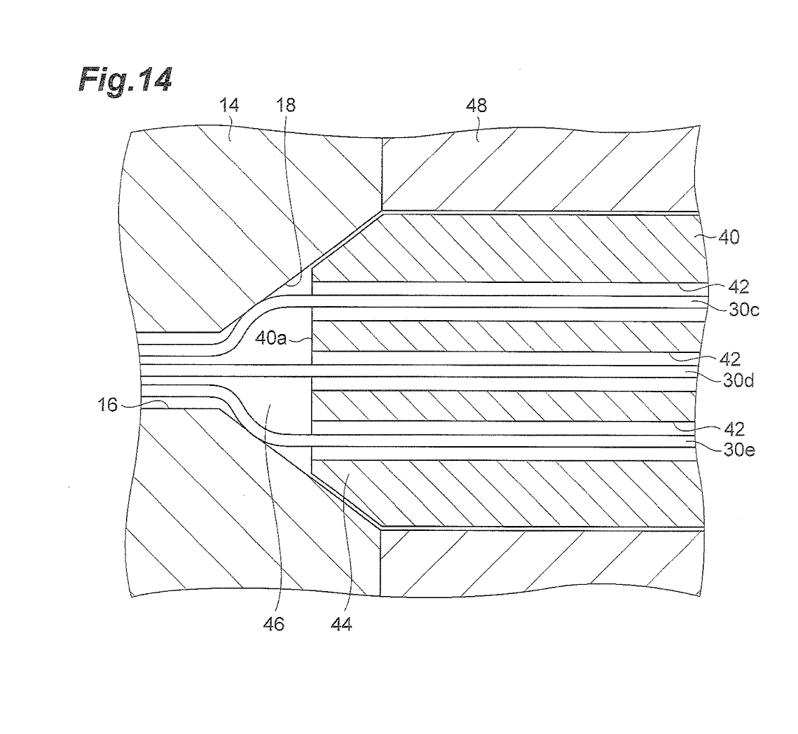

As illustrated in FIG. 14, the alignment sleeve 40 is formed with a taper part 44 so as to narrow its leading end toward the ferrule 14. The ferrule 14 has an insertion port 18 for receiving the taper part 44. The alignment sleeve 40 and the ferrule 14 are secured to through a fixing member 48 while the taper part 44 and the insertion port 18 abut against each other.

A leading end face 40a of the alignment sleeve 40 is constructed so as to fall short of reaching the through hole 16 of the ferrule 14. This forms a gap 46 between the taper part 44 and the through hole 16. The gap 46 is defined by the insertion port 18, through hole 16, and leading end face 40a. That is, the insertion port 18 is disposed against the gap 46.

The gap 46 allows the optical fibers 30a to 30g to be introduced into the through hole 16 having a smaller diameter without changing their arrangement. This reduces the center distances E1, E2 in the vertical direction D2 of the optical fibers 30a to 30g to the center distances E3, E4. At this time, the leading ends of the optical fibers 30a, 30b, 30c, 30e, 30f, 30g are guided to the inside along the taper surface of the insertion port 18, so as to be introduced into the through hole 16.

Further, as illustrated in FIGS. 15 and 16 and the like, the wall between the through holes 42a to 42g has a thickness E6 smaller than the inner diameter E5 of each of the through holes 42a to 42g. As a consequence, the through holes 42a to 42g are separated from each other by the thickness E6 smaller than their inner diameter E5. This restricts the degree of freedom in movement of the optical fibers 30a to 30g in the gap 46. Therefore, the optical fibers 30a to 30g can be introduced into the through hole 16 without changing their arrangement.

The optical connector 1 of this embodiment makes it harder for the optical fibers 30a to 30g extending from the inner surface 20b of the second end 20 to twist in the space 60. Therefore, the cores of the MCF 3 can be converted into another arrangement while keeping their optical characteristics favorably.

The alignment sleeve 40 can easily set the first arrangement and the second arrangement. Further, the center distances E1, E2 in the vertical direction D2 of the optical fibers 30a to 30g in the alignment sleeve 40 are greater than the center distances E3, E4 in the vertical direction D2 of the first arrangement. Therefore, the optical fibers 30a to 30g can easily be inserted into the through holes 42a to 42g. Further, the gap 46 can guide the optical fibers 30a to 30g easily into the through hole 16 of the ferrule 14. The space 60 is so wide that the optical fibers 30a to 30g can be prevented from twisting in the space 60.

The first arrangement and the second arrangement, which are the arrangements of the optical fibers 30a to 30g in the first end 10 and the second end 20, will now be explained with reference to FIGS. 6A and 6B. The first arrangement is based on the arrangement of the through holes 42a to 42g in the alignment sleeve 40. In the following, the arrangements of the optical fibers 30a to 30g will be explained on the assumption that the arrangement of the through holes 42a to 42g is equivalent to the first arrangement.

As illustrated in FIGS. 6A and 6B, the through holes 42a to 42g are arranged in first fiber juxtaposition parts 61C, 61B, 61A at the first, second, and third stages in the vertical direction D2. The first fiber juxtaposition part 61C at the first stage includes two through holes 42f, 42g. The first fiber juxtaposition part 61B at the second stage includes three through holes 42c, 42d, 42e. The first fiber juxtaposition part 61A at the third stage includes two through holes 42a, 42b. The one ends of the optical fibers 30a, 30b are arranged separately from each other in the horizontal direction D1 in the first fiber juxtaposition part 61A. The one ends of the optical fibers 30c, 30d, 30e are arranged in the horizontal direction D1 in the first fiber juxtaposition part 61B. The one ends of the optical fibers 30f, 30g are arranged in the horizontal direction D1 in the first fiber juxtaposition part 61C. The first fiber juxtaposition parts 61A, 61B, 61C arrange the one ends of the optical fibers 30a to 30g into the first arrangement.

The second end 20 is provided with a second fiber juxtaposition part 62. The other ends of the optical fibers 30a to 30g are arranged separately from each other in the horizontal direction D1 in the second fiber juxtaposition part 62. The second fiber juxtaposition part 62 is provided by one stage (M=1), whose number is smaller than the number of stages (N=3) of the first fiber juxtaposition parts 61A, 61B, 61C. The second fiber juxtaposition part 62 arranges the other ends of the optical fibers 30a to 30g into the second arrangement. The other ends of the seven optical fibers 30a to 30g are arranged in the second fiber juxtaposition parts 62. The respective optical fibers 30a to 30g in the second end 20 include fiber sets constituted by optical fibers having one ends arranged at the n-th stage (in the fiber juxtaposition part 61n at the n-th stage) in the first end 10. That is, they include a first fiber set FA arranged at the first stage, a second fiber set FB arranged at the second stage, and a third fiber set FC arranged at the third stage.

The first fiber set FA includes two optical fibers 30a, 30b. The optical fibers 30a, 30b have respective one ends arranged at the third stage in the first end 10. The optical fibers 30a, 30b are arranged at both ends of the first fiber set FA (as first optical fibers). Such an arrangement prevents the optical fibers 30a, 30b from coming into contact by intersecting between the first end 10 and the second end 20.

Further, the optical fibers 30a, 30b are adjacent in the first end 10 and the second end 20. Therefore, the optical fibers 30a, 30b can be introduced together into the alignment sleeve 40, ferrule 14, and the like. Further, the optical fibers 30a, 30b may be integrated into a ribbon in the space 60 for making them easier to introduce.

The second fiber set FB includes three optical fibers 30c, 30d, 30e. The optical fibers 30c, 30d, 30e have respective one ends arranged at the second stage in the first end 10. The optical fibers 30c, 30e are arranged at both ends of the second fiber set FB (as first optical fibers). Further, the second fiber set FB further comprises the optical fiber 30d arranged adjacent to the optical fibers 30c, 30e in the second end 20 (as a second optical fiber). The optical fiber 30d is arranged adjacent to the optical fibers 30c, 30e in the first end 10. Such an arrangement prevents the optical fibers 30c, 30e from coming into contact by intersecting between the first end 10 and the second end 20.

Further, the optical fibers 30c, 30d, 30e are adjacent in the first end 10 and the second end 20. Therefore, the optical fibers 30c, 30d, 30e can be introduced, together into the alignment sleeve 40, ferrule 14, and the like. Further, the optical fibers 30c, 30d, 30e may be integrated into a ribbon in the space 60 for making them easier to introduce.

The third fiber set FC includes two optical fibers 30f, 30g. The optical fibers 30f, 30g have respective one ends arranged at the first stage in the first end 10. The optical fibers 30f, 30g are arranged at both ends of the third fiber set FC (as first optical fibers). Such an arrangement prevents the optical fibers 30f, 30g from coming into contact by intersecting between the first end 10 and the second end 20.

Further, in the third fiber set FC, the optical fibers 30f, 30g are adjacent in the first end 10 and the second end 20. Therefore, the optical fibers 30f, 30g can be introduced together into the alignment sleeve 40, ferrule 14, and the like. Further, the optical fibers 30f, 30g may be integrated into a ribbon in the space 60 for making them easier to introduce.

In the optical connector 1, N=3 in the first arrangement, and M=1 in the second arrangement. The plurality of optical fibers arranged in the second end 20 include the first fiber set FA, second fiber set FB, and third fiber set FC. The first fiber set FA corresponds to the third stage (n=3) of the first arrangement. The second fiber set FB corresponds to the second stage (n=2) of the first arrangement. The third fiber set FC corresponds to the first stage (n=1) of the first arrangement.

The optical fibers 30a, 30b included in the first fiber set FA are adjacent in the second end 20. The optical fibers 30c, 30d, 30e included in the second fiber set FB are adjacent in the second end 20. The optical fibers 30f, 30g included in the third fiber set FC are adjacent in the second end 20. Further, the second fiber set FB is interposed between the first fiber set FA and the third fiber sets FC.

The optical fibers 30a, 30b arranged at the first stage in the first end 10 do not intersect each other in the space 60 as seen in the second direction D2. Further, the optical fibers 30c, 30d, 30e arranged at the second stage in the first end 10 do not intersect each other in the space 60 as seen in the second direction D2. The optical fibers 30f, 30g arranged at the third stage in the first end 10 do not intersect each other in the space 60 as seen in the second direction D2. This prevents the optical fibers 30a to 30g from worsening their optical characteristics by coming into contact with each other.

In the optical connector 1, the plurality of optical fibers arranged in the second end include an optical fiber set constituted by optical fibers having one ends placed at the n-th stage in the first end, the optical fiber set includes the first optical fibers arranged at ends of the fiber set in the second end, and the first optical fibers have one ends arranged at the n-th stage in the first end. Therefore, this reduces the deviation along the first direction D1 between respective positions where both ends of each of the optical fibers 30a to 30g are arranged.

In the optical connector 1, a fiber set further comprises the second optical fiber arranged adjacent to the first optical fibers in the second end, while the second optical fiber is arranged adjacent to the first optical fibers in the first end. Therefore, the adjacent optical fibers can be integrated into a ribbon or the like, so as to be introduced together into the alignment sleeve 40, ferrule 14, and the like.

### Second Embodiment

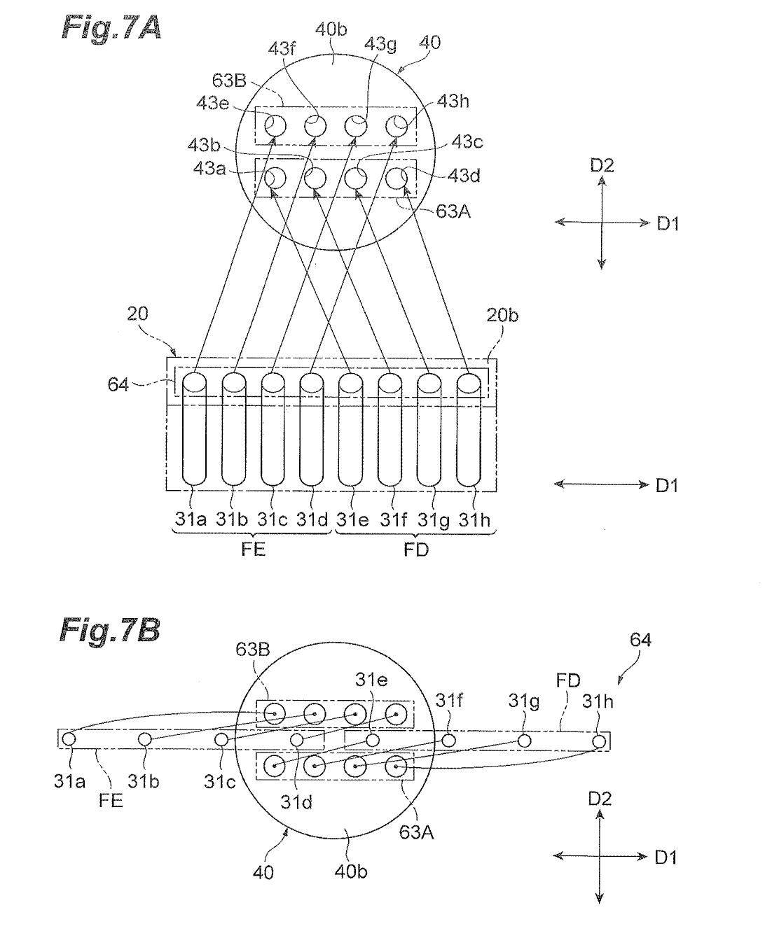

The optical connector in accordance with the second embodiment will now be explained. As illustrated in FIGS. 7A and 7B, the optical connector in accordance with the second embodiment comprises eight optical fibers 31a, 31b, 31c, 31d, 31e, 31f, 31g, 31h.

Through holes 43a to 43h are arranged in first fiber juxtaposition parts 63B, 63A at the first stage and the second stage in the vertical direction D2. The first fiber juxtaposition part 63B at the first stage includes four through holes 43e, 43f, 43g, 43h. The first fiber juxtaposition part 63A at the second stage includes four through holes 43a, 43b, 43c, 43d. The eight optical fibers 31a to 31h have one ends arranged in their corresponding first fiber juxtaposition parts 63A, 63B. The first fiber juxtaposition parts 63A, 63B construct a two-stage first arrangement.

The second end 20 is provided with a second fiber juxtaposition part 64. The other ends of the eight optical fibers 31a to 31h are arranged in the second fiber juxtaposition part 64. The optical fibers 31a to 31h in the second end 20 include a first fiber set FD arranged at the first stage and a second fiber set FE arranged at the second stage in the first end 10.

The first fiber set FD includes four optical fibers 31e, 31f, 31g, 31h. The optical fibers 31e, 31f, 31g, 31h have one ends arranged at the first stage. The second fiber set FE includes four optical fibers 31a, 31b, 31c, 31d. The optical fibers 31a, 31b, 31c, 31d have one ends arranged at the second stage.

The optical fibers 31e, 31h are arranged at both ends of the first fiber set FD in the second end 20 (as first optical fibers). Further, the optical fibers 31e, 31h have respective one ends arranged at both ends of the row of optical fibers placed at the second stage in the first end 10. Further, the optical fibers 31a, 31d are arranged at both ends of the second fiber set FE in the second end 20 (as first optical fibers). Further, the optical fibers 31a, 31d have one ends arranged at both ends of the row of optical fibers placed at the first stage in the first end 10. Such an arrangement prevents the optical fibers from coming into contact by intersecting. Further, the deviation in the first direction between respective positions where both ends of each optical fiber are arranged also becomes smaller.

In the first end 10 and the second end 20, the optical fibers 31f, 31g are adjacent to the optical fibers 31e, 31h arranged at both ends of the first fiber set FD, respectively. Therefore, the optical fibers 31f, 31g are examples of the second optical fibers in the present invention. In each of the first end 10 and the second end 20, the optical fibers 31b, 31c are adjacent to the optical fibers 31a, 31d arranged at both ends of the second fiber set FE, respectively. Therefore, the optical fibers 31a, 31d are examples of the second optical fibers in the present invention. This configuration reduces the deviation in the first direction between respective positions where both ends of each optical fiber are arranged. As a consequence, bends occurring in the optical fibers between one ends and other ends become smaller.

Further, in the first end 10 and the second end 20, the optical fibers 31e, 31f, 31g, 31h are adjacent to the optical fibers 31a, 31b, 31c, 31d. Therefore, they can be integrated into a ribbon, for example, so as to be introduced together into the alignment sleeve 40, ferrule 14, and the like.

Further, The optical fibers 31e to 31h in the first fiber set FD may have one ends arranged at the first stage. Further, the optical fibers 31a to 31d in the second fiber set FE may have one ends arranged at the second stage.

The present invention, is not limited to the above-mentioned embodiments but may be modified in various ways.

### MODIFIED EXAMPLE 1

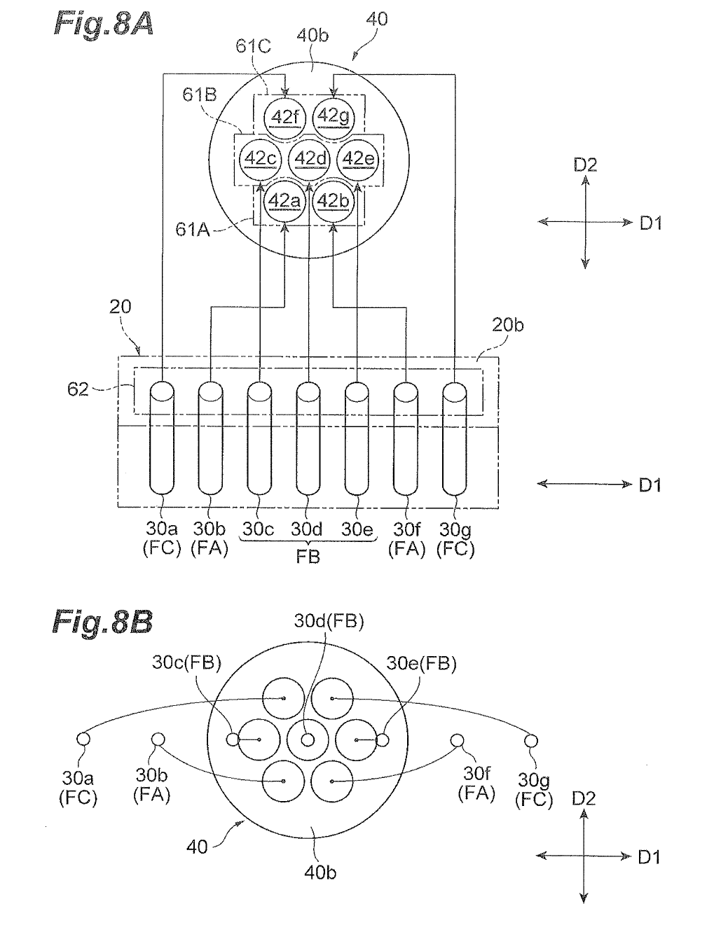

The relationship between the first arrangement and the second arrangement of optical fibers 30a to 30g may be in the mode illustrated in FIGS. 8A and 8B.

The first fiber set FA include two optical fibers 30b, 30f. The optical fibers 30b, 30f have one ends arranged in the first fiber juxtaposition part 61A at the third stage. The optical fibers 30b, 30f have one ends arranged at both ends of the first fiber set FA in the second end 20. The optical fibers 30b, 30f are not adjacent to each other in the second end 20.

The second fiber set FB includes three optical fibers 30c, 30d, 30e. The optical fibers 30c, 30d, 30e have one ends arranged in the first fiber juxtaposition part 61B at the second stage. The optical fibers 30c, 30e have one ends arranged at both ends of the second fiber set FB in the second end 20. The optical fiber 30d has one end arranged at the center of the first fiber juxtaposition part 61B. The optical fibers 30c, 30d, 30e are adjacent to each other in the second end 20.

The third fiber set FC includes two optical fibers 30a, 30g. The optical fibers 30a, 30g have one ends arranged in the first fiber juxtaposition part 61C at the first stage. The optical fibers 30a, 30g have one ends arranged at both ends of the third fiber set FC in the second end 20. The optical fibers 30a, 30g are not adjacent to each other in the second end 20.

The optical fiber 30d is arranged at the center in the second end 20 and at the center of the second stage in the first end 10. In the second end 20, the optical fibers 30a to 30c and 30e to 30g are arranged offset with respect the optical fiber 30d in the first direction D1. And, they are also arranged offset from the optical fiber 30d in the first direction D1 in the first end 10.

More specifically, in the second end 20, the optical fibers 30a to 30c are arranged offset to one side in the first direction D1 with respect with respect the optical fiber 30d placed at the center. In the first end 10, the optical fibers 30a to 30c are arranged offset to one side in the first direction D1.

Furthermore, in the second end 20, the optical fibers 30e to 30g are arranged offset to the other side in the first direction D1 with respect the optical fiber 30d placed at the center. And, in the first end 10, the optical fibers 30e to 30g are arranged offset to the other side in the first direction D1.

Such an arrangement can convert each of the optical paths of a three-stage arrangement of a multicore fiber to a one-stage arrangement while preventing optical characteristics from deteriorating. Further, this reduces the deviation in the first direction D1 between respective positions where both ends of each of the optical fibers 30a to 30g are arranged. As a consequence, bends occurring in the optical fibers 30a to 30g become smaller. Hence, stresses acting on the optical fibers 30a to 30g can be mitigated.

### MODIFIED EXAMPLE 2

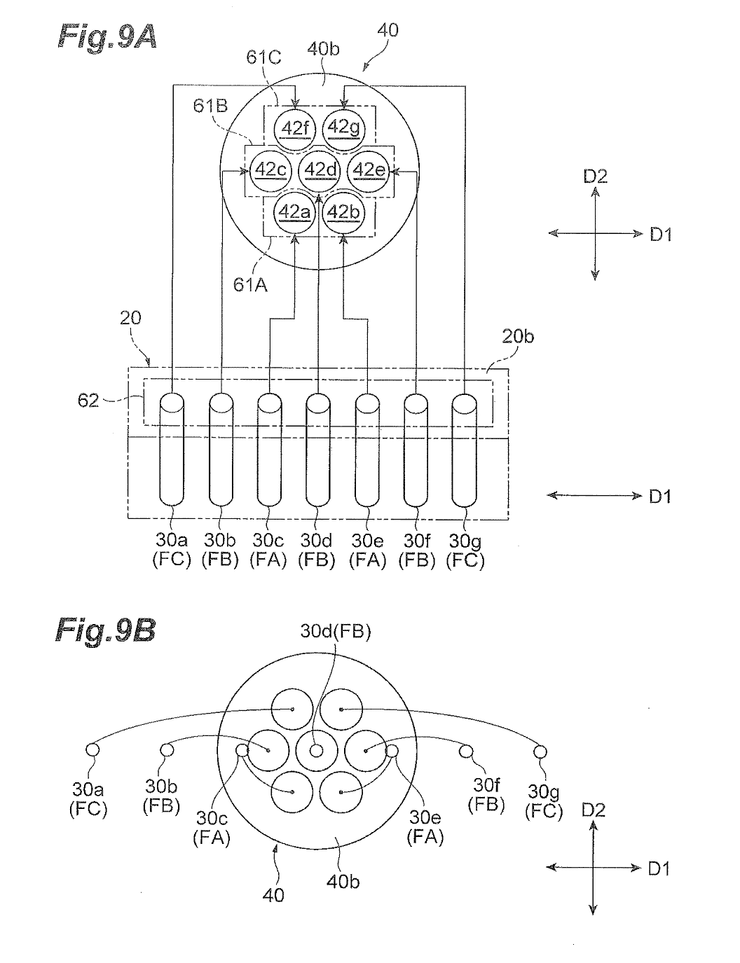

The relationship between the first arrangement and the second arrangement of optical fibers 30a to 30g may be in the mode illustrated in FIGS. 9A and 9B.

The first fiber set FA includes two optical fibers 30c, 30e. The optical fibers 30c, 30e have one ends arranged in the first fiber juxtaposition part 61A at the third stage. The optical fibers 30c, 30e have one ends arranged at both ends of the first fiber set FA in the second end 20. The optical fibers 30c, 30e are not adjacent to each other in the second end 20.

The second fiber set FB includes three optical fibers 30b, 30d, 30f. The optical fibers 30b, 30d, 30f have one ends arranged in the first fiber juxtaposition part 61B at the second stage. The optical fibers 30c, 30e have one ends arranged at both ends of the second fiber set FB in the second end 20. The optical fibers 30b, 30d, 30f are not adjacent to each other in the second end 20. Further, the optical fiber 30d is arranged at the center of the second stage in the first end 10 and the second end 20.

The third fiber set FC includes two optical fibers 30a, 30g. The optical fibers 30a, 30g have one ends arranged in the first fiber juxtaposition part 61C at the first stage. The optical fibers 30a, 30g have one ends arranged at both ends of the third fiber set FC in the second end 20. The optical fibers 30a, 30g in the third fiber set FC are not adjacent to each other in the second end 20.

The optical fiber 30d is arranged at the center in the second end 20 and at the center of the second stage in the first end 10. The optical fibers 30a to 30c and 30e to 30g are arranged offset in the first direction D1 with respect the optical fiber 30d in the second end 20. Further, they are also arranged offset to the same sides in the first direction D1 in the first end 10.

More specifically, in the second end 20, the optical fibers 30a to 30c are arranged offset to one side in the first direction D1 with respect the optical fiber 30d placed at the center. Further, in the first end 10, the optical fibers 30a to 30c are arranged offset to one side in the first direction D1.

Furthermore, In the second end 20, the optical fibers 30e to 30g are arranged offset to the other side in the first direction D1 with respect the optical fiber 30d placed at the center. In the first end 10, the optical fibers 30e to 30g are arranged offset to the other side in the first direction D1

Such an arrangement can convert each of the optical paths of a three-stage arrangement of a multicore fiber to a one-stage arrangement while preventing optical characteristics from deteriorating. Further, this also reduces the deviation in the first direction D1 between respective positions where both ends of each of the optical fibers 30a to 30g are arranged. As a consequence, bends occurring in the optical fibers 30a to 30g become smaller. Hence, stresses acting on the optical fibers 30a to 30g can be mitigated.

### MODIFIED EXAMPLE 3

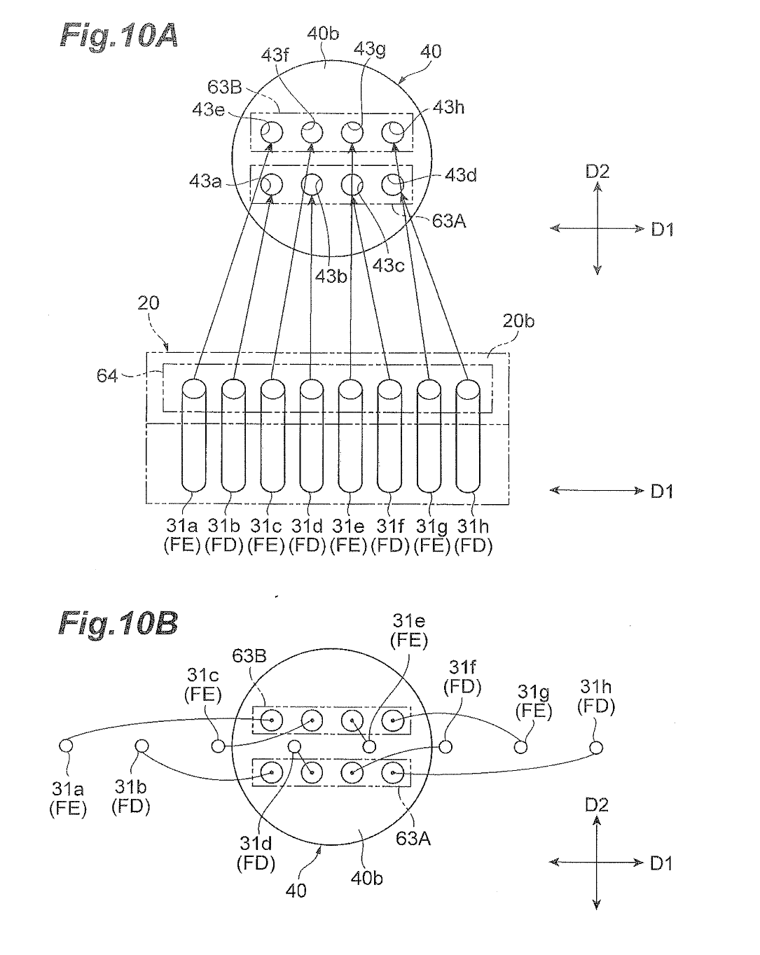

The relationship between the first arrangement and the second arrangement of optical fibers 31a to 31h may be in the mode illustrated in FIGS. 10A and 10B.

The first fiber set FD includes four optical fibers 31b, 31d, 31f, 31h. The optical fibers 31b, 31d, 31f, 31h have one ends arranged in the first fiber juxtaposition part 63A at the second stage. The optical fibers 31b, 31d have one ends arranged at both ends of the first fiber set FD in the second end 20. The optical fibers 31b, 31d, 31f, 31h are not adjacent to each other in the second end 20.

The second fiber set FE includes four optical fibers 31a, 31c, 31e, 31g. The optical fibers 31a, 31c, 31e, 31g have one ends arranged in the first fiber juxtaposition part 63B at the first stage. The optical fibers 31a, 31e have one ends arranged at both ends of the second fiber set FE in the second end 20. The optical fibers 31a, 31c, 31e, 31g are not adjacent to each other in the second end 20.

Further, The optical fibers 31b, 31d, 31f, 31h in the first fiber set FD may have one ends arranged in the first fiber juxtaposition part 63B at the first stage. Further, the optical fibers 31a, 31c, 31e, 31g in the second fiber set FE may have one ends arranged in the first fiber juxtaposition part 63A at the second stage.

The optical fiber arranged at the r-th position, where r is a natural number satisfying k≧r≧1, in the first direction D1 of the first stage in the first end 10 is arranged at the (2×r−1)-th position in the first direction D1 in the second end 20. On the other hand, the optical fiber arranged at the r-th position in the first direction D1 at the second stage in the first end 10 is arranged at the (2×r)-th position in the first direction D1 in the second end 20.

Specifically, in the first end 10, the optical fibers 31a, 31c, 31e, 31g are arranged at the first to fourth positions (r=1 to 4) in the first direction D1 at the first stage. In the second end 20, the optical fibers 31a, 31c, 31e, 31g are arranged at the first (2×1−1), third (2×2−1), fifth (2×3−1), and seventh (2×4−1) positions in the first direction D1.

In the first end 10, the optical fibers 31b, 31d, 31f, 31h are arranged at the first to fourth positions (r=1 to 4) in the first direction D1 at the second stage. In the second end 20, the optical fibers 31b, 31d, 31f, 31h are arranged at the second (2×1), fourth (2×2), sixth (2×3), and eighth (2×4) positions in the first direction D1.

Such an arrangement can convert optical paths of a two-stage arrangement of a multicore fiber to a one-stage arrangement while preventing optical characteristics from deteriorating. This reduces the deviation in the first direction D1 between respective positions where both ends of the optical fibers 31a to 31h are arranged. As a consequence, bends occurring in the optical fibers 31a to 31h become smaller. Hence, stresses acting on the optical fibers 31a to 31h can be mitigated.

### MODIFIED EXAMPLE 4

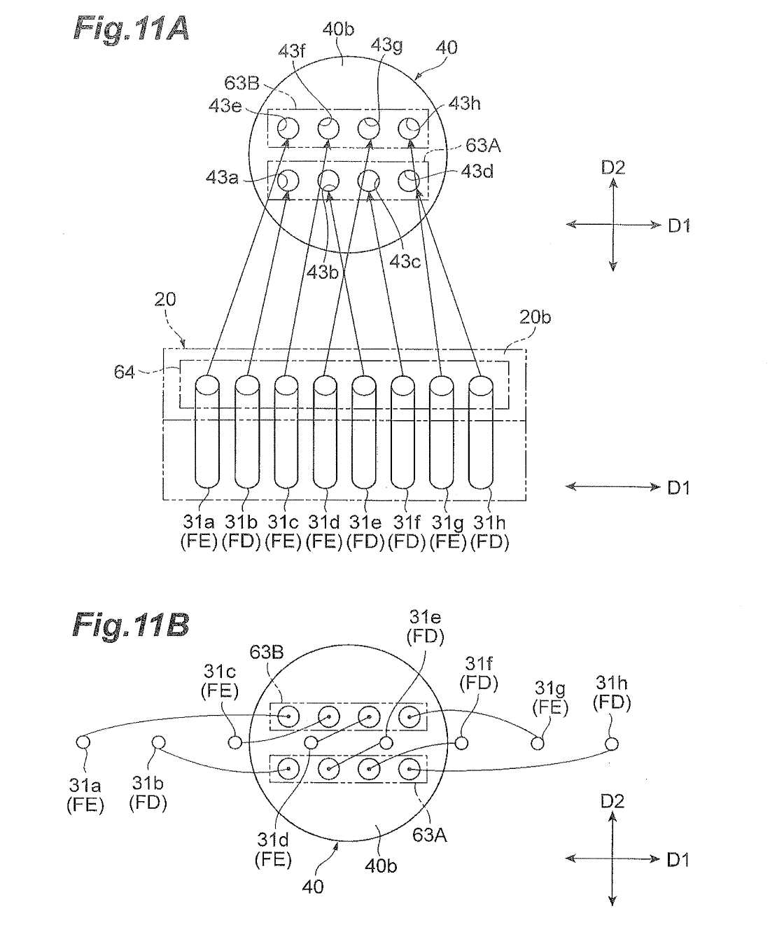

The relationship between the first arrangement and the second arrangement of optical fibers 31a to 31h may be in the mode illustrated in FIGS. 11A and 11B.

The first fiber set FD includes four optical fibers 31b, 31e, 31f, 31h. The optical fibers 31b, 31e, 31f, 31h have one ends arranged in the first fiber juxtaposition part 63A at the second stage. The optical fibers 31b, 31f have one ends arranged at both ends of the first fiber set FD in the second end 20. The optical fibers 31e, 31f are adjacent to each other in the second end 20.

The second fiber set FE includes four optical fibers 31a, 31c, 31d, 31g. The optical fibers 31a, 31c, 31d, 31g have one ends arranged in the first fiber juxtaposition part 63B at the first stage. The optical fibers 31a, 31d have one ends arranged at both ends of the second fiber set FE in the second end 20. The optical fibers 31c, 31d are adjacent to each other in the second end 20.

Further, The optical fibers 31b, 31e, 31f, 31h in the first fiber set FD may have one ends arranged in the first fiber juxtaposition part 63B at the first stage. Further, the optical fibers 31a, 31e, 31d, 31g in the second fiber set FE may have one ends arranged in the first fiber juxtaposition part 63A at the second stage.

### MODIFIED EXAMPLE 5

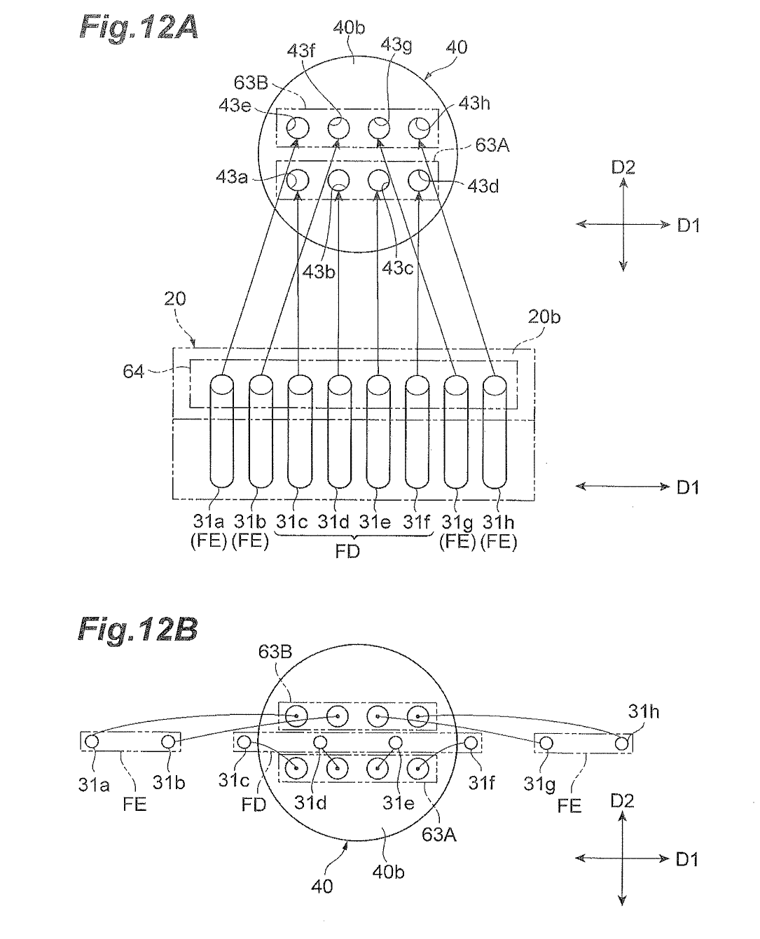

The relationship between the first arrangement and the second arrangement of optical fibers 31a to 31h may be in the mode illustrated in FIGS. 12A and 12B.

The first fiber set FD includes four optical fibers 31c, 31d, 31e, 31f. The optical fibers 31c, 31d, 31e, 31f have one ends arranged in the first fiber juxtaposition part 63A at the second stage. The optical fibers 31c, 31e have one ends arranged at both ends of the first fiber set FD in the second end 20. The optical fibers 31c, 31d are adjacent in the second end 20. Further, the optical fibers 31f, 31e are also adjacent.

The second fiber set FE includes four optical fibers 31a, 31b, 31g, 31h. The optical fibers 31a, 31b, 31g, 31h have one ends arranged in the first fiber juxtaposition part 63B at the first stage. The optical fibers 31a, 31g have one ends arranged at both ends of the second fiber set FE in the second end 20. The optical fibers 31a, 31b are adjacent in the second end 20. Further, the optical fibers 31g, 31h are also adjacent.

The optical fibers adjacent in the first end 10 and the second end 20 (the optical fibers 31c and 31d, 31f and 31e, 31a and 31b, and 31g and 31h) may be integrated into a ribbon. This allows a plurality of optical fibers to be introduced together into the alignment sleeve 40, ferrule 14, and the like.

Further, The optical fibers 31c, 31d, 31e, 31f in the first fiber set FD may have one ends arranged in the first fiber juxtaposition part 63B at the first stage. Further, the optical fibers 31a, 31b, 31g, 31h in the second fiber set FE may have one ends arranged in the first fiber juxtaposition part 63A at the second stage.

### MODIFIED EXAMPLE 6

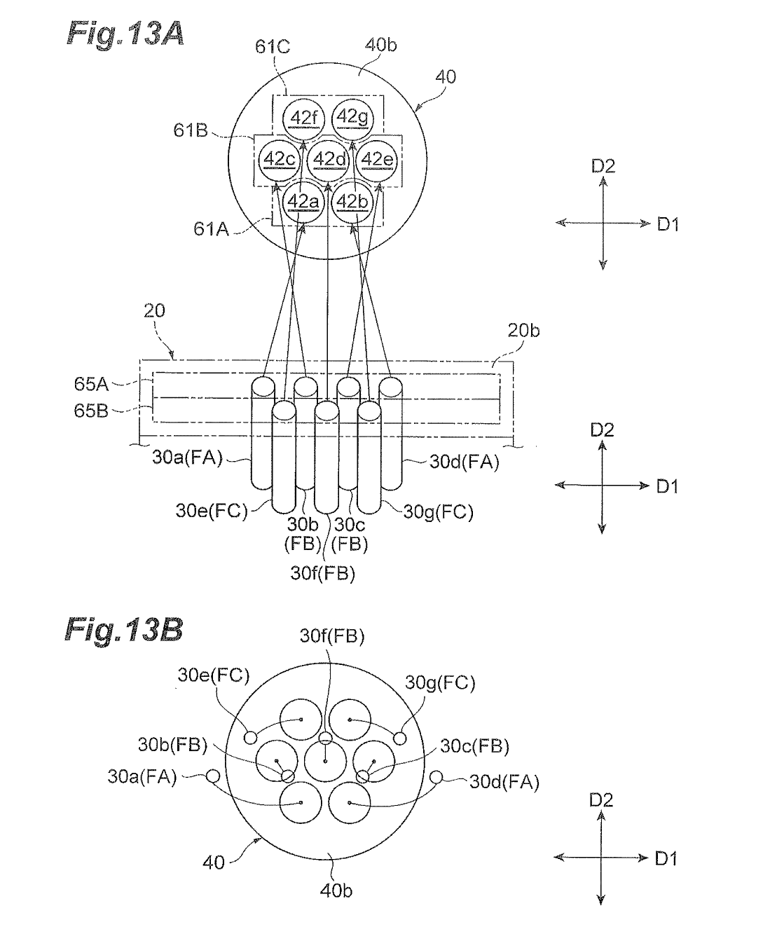

The relationship between the first arrangement and the second arrangement of optical fibers 30a to 30g may be in the mode illustrated in FIGS. 13A and 13B. That is, the second fiber juxtaposition part may have two stages.

The second end 20 is provided with a second fiber juxtaposition part 65A at the second stage. Further, the second fiber juxtaposition part 65A is constructed such that the other ends of optical fibers are separated from each other in the first direction D1. Another second juxtaposition part 65B is provided on one side of the former in the second direction D2. Four optical fibers 30a, 30b, 30c, 30d have other ends arranged in the second fiber juxtaposition part 65A. Three optical fibers 30e, 30f, 30g have other ends arranged in the second fiber juxtaposition part 65B. The optical fibers 30a, 30b, 30c, 30d deviate from the optical fibers 30e, 30f, 30g in the second direction D2.

The first fiber set FA includes two optical fibers 30a, 30d. The optical fibers 30a, 30d have one ends arranged in the first fiber juxtaposition part 61A at the third stage. The second fiber set FB includes three optical fibers 30b, 30c, 30f. The optical fibers 30b, 30c, 30f have one ends arranged in the first fiber juxtaposition part 61B at the second stage. The third fiber set FC includes two optical fibers 30e, 30g. The optical fibers 30e, 30g have one ends arranged in the first fiber juxtaposition part 61C at the first stage.

Such first arrangement and second arrangement can reduce the width of the second end 20 in the first direction D1.

### OTHER MODIFIED EXAMPLES

The optical connector of any of the embodiments may further comprise a lid for covering the ferrule 14, alignment sleeve 40, and the like. This can seal the inside of the optical connector.

Further, the alignment sleeve 40 may have a length longer than the distance from the inner surface 20b of the second end 20 to the end face 40b of the alignment sleeve 40. This configuration can make the optical fibers shorter in the space 60. This can prevent the optical fibers from coming into contact with each other.

What is claimed is:

1. An optical connector for converting an arrangement of a plurality of optical paths provided in a cladding of a multicore fiber from a first arrangement to a second arrangement, the optical connector comprising:
a plurality of optical fibers for providing optical paths optically connectable to the respective optical paths of the multicore fiber;
a first end for placing one end of a plurality of the optical fibers in the first arrangement;
a second end for arranging the other end of a plurality of the optical fibers or a middle part thereof in the second arrangement; and
a space located between the first end and the second end such that a plurality of the optical fibers extend therethrough from the first end to the second end;
wherein the first arrangement includes one or a plurality of the optical paths arranged in a first direction, and a plurality of the optical paths arranged in N stages in a second direction intersecting the first direction;
wherein the second arrangement includes one or a plurality of the optical paths arranged in the first direction, and a plurality of the optical paths arranged in M stages in the second direction, where N and M are natural numbers, and N>M; and
wherein a plurality of the optical fibers arranged at the n-th stage in the first end, where N≧n≧1, are kept from intersecting each other in the space as seen in the second direction.

2. The optical connector according to claim 1, wherein a plurality of the optical fibers arranged in the second end include an optical fiber set constituted by the optical fibers having the one end placed at the n-th stage in the first end;
wherein the optical fiber set includes a first optical fiber arranged at an end of the fiber set in the second end; and
wherein the one end of the first optical fiber is arranged at an end of the optical fiber placed at the nth stage in the first end.

3. The optical connector according to claim 2, wherein the fiber set further comprises a second optical fiber arranged adjacent to the first optical fiber in the second end; and
wherein the second optical fiber is arranged adjacent to the first optical fiber in the first end.

4. The optical connector according to claim 3, wherein the first optical fiber and the second optical fiber are integrated into a ribbon in the space.

5. The optical connector according to claim 2, wherein N=3 in the first arrangement;
wherein M=1 in the second arrangement;
wherein the optical fiber set at the first stage (n=1) includes two of the optical fibers;
wherein the optical fiber set at the second stage (n=2) includes three of the optical fibers;
wherein the optical fiber set at the third stage (n=3) includes two of the optical fibers;
wherein the optical fiber set at the second stage of the first arrangement includes the optical fiber arranged at a center in the second end and at a center of the second stage in the first end; and
wherein the optical fiber arranged offset in the first direction from the optical fiber arranged at the center of the second stage in the second end is arranged at an end in the first direction of a plurality of the optical fibers at the second stage in the first end.

6. The optical connector according to claim 2, wherein N=2 in the first arrangement;
wherein M=1 in the second arrangement;
wherein the optical fiber set at the first stage (n=1) in the first arrangement includes k of the optical fibers;
wherein the optical fiber set at the second stage (n=2) in the first arrangement includes k of the optical fibers;
wherein the optical fiber arranged at the r-th position, where r is a natural number satisfying k≧r≧1, in the first direction of the first stage in the first end is arranged at the (2×r−1)-th position in the first direction in the second end; and
wherein the optical fiber arranged at the r-th position in the first direction at the second stage in the first end is arranged at the (2×r)-th position in the first direction in the second end.

7. The optical connector according to claim 2, wherein N=3 in the first arrangement;
wherein M=1 in the second arrangement;
wherein a first fiber set corresponding to the first stage (n=1) in the first arrangement, a second fiber set corresponding to the second stage (n=2) in the first arrangement, and a third fiber set corresponding to the third stage (n=3) in the first arrangement are formed in the second end;
wherein the optical fibers included in each of the first, second, and third fiber sets are adjacent to each other in the second end; and
wherein the second fiber set is held between the first fiber set and the third fiber set.

8. The optical connector according to claim 1, further comprising a ferrule;
wherein the ferrule is arranged in the space, secured to the first end, and the optical fiber is inserted therethrough; and
wherein a length of the ferrule is longer than that of the optical fiber from the ferrule to the second end.

9. The optical connector according to claim 1, further comprising a ferrule;
wherein the ferrule is arranged in the space, secured to the first end, and the optical fiber is inserted therethrough; and
wherein a length of the ferrule is shorter than that of the optical fiber from the ferrule to the second end.

10. The optical connector according to claim 1, further comprising an alignment part, placed in the space, for aligning a plurality of the optical fibers extending from the second end into the N stages.

11. The optical connector according to claim 10, wherein an interval between a plurality of the optical fibers in the respective stages in the alignment part is greater than that in the first arrangement.

12. The optical connector according to claim 10, wherein the first end has an arrangement region for placing the plurality of optical fibers in the first arrangement, while forming a gap between the arrangement region and a leading end of the alignment part; and
wherein, in the gap, an interval between a plurality of the optical fibers in the respective stages in the alignment part is converted into an interval between a plurality of the optical fibers in the respective stages in the first arrangement.

13. The optical connector according to claim 12, wherein the alignment part is secured to the first end; and
wherein the first end has a taper in at least a part of a region disposed against the gap.

14. The optical connector according to claim 10, wherein the alignment part has a plurality of through holes for aligning the optical fibers; and
wherein a width between the through holes is smaller than an inner diameter of the through hole.

15. The optical connector according to claim 10, wherein the space is greater than the width of the first arrangement and the width of the second arrangement in a direction intersecting the opposing direction of the first end and the second end.
